(19) United States
(12) Patent Application Publication
(10) Pub. No.: US 2009/0178880 A1
(43) Pub. Date: Jul. 16, 2009

(54) Air-Suction-Noise Reduction Device and Working Machine With the Same

(75) Inventors: Atsushi Uemura, Shikokuchuo-shi (JP); Koji Okazawa, Shanghai (CN); Mitsuo Yabe, Hiratsuka-shi (JP); Kazuya Imamura, Fujisawa-shi (JP); Mikio Iwasaki, Hirakata-shi (JP); Sueyoshi Nishimine, Hirakata-shi (JP)

Correspondence Address: FOX ROTHSCHILD LLP, 2000 MARKET STREET, 10th Floor, PHILADELPHIA, PA, 19103, US

(73) Assignee: KOMATSU LTD., Tokyo (JP)

(21) Appl. No.: 12/159,450

(22) PCT Filed: Jan. 12, 2007
(86) PCT No.: PCT/JP2007/050300

§ 371 Date: Jun. 27, 2008

(30) Foreign Application Priority Data
Jan. 20, 2006 (JP) 2006-012593

(51) Int. Cl. F02M 35/12

(52) U.S. Cl. 181/229

(57) ABSTRACT

An engine cover 17 has a cover main body 19 and an engine hood 20 which is attached to an opening portion formed on an upper surface of the cover main body 19 and a plurality of reinforcing plates 24 are fixed to an inner surface of the engine hood 20. First to fourth reinforcing plates 24a to 24d of a plurality of reinforcing plates 24 define a space in an engine portion 14. An expansion chamber 26 which is communicated with an intake passage 23 reaching to an engine and resonant chambers 27, 28 which are communicated with the expansion chamber 26 via ports 29 are formed in the engine portion 14.

### FIELD OF THE INVENTION

The present invention relates to an air suction noise reduction device (generally referred to as a resonator) which reduces intake noise generated at an air intake side of an engine or resonance noise which is generated in an air intake passage due to noise from an engine, and also relates to a work machine such as a bulldozer with the air suction noise reduction device.

### BACKGROUND OF THE INVENTION

Such an air suction noise reduction device has been disclosed in Patent Document 1. In the air suction noise reduction device, an expansion chamber having a substantially box shape is provided separately from a vehicle body on an air intake passage which is connected to an engine. A resonant chamber having a substantially box shape is provided separately from the vehicle body outside of the expansion chamber. A connection port of a cylindrical shape is provided in the resonant chamber and the connection port is inserted into the expansion chamber. This connects inside spaces of the expansion chamber and the resonant chamber with each other. Out of the intake noise generated from the air intake side of the engine, the intake noise of a frequency band corresponding to the volume of the resonant chamber is reduced.

### Patent Document 1: Japanese Laid-Open Patent Publication No. 10-311259

### SUMMARY OF THE INVENTION

However, according to the air suction noise reduction device as described above, the expansion chamber and the resonant chamber are dedicated box-shaped parts which are provided separately from the vehicle body. Therefore, box-shaped members, which form the expansion chamber and the resonant chamber, and the connection member which connects the expansion chamber and the resonant chamber are required. This makes a structure of the air suction noise reduction device complicated and a space for the air suction noise reduction device is necessary to be prepared in an engine compartment.

An objective of the present invention is to provide an air suction noise reduction device which has a simple structure, is produced with low cost, and requires no mounting space.

According to a first aspect of the present invention, an air suction noise reduction device is provided in which a resonant chamber having an intake noise reducing function is connected to an intake passage via a port, the intake passage reaching to an engine which is accommodated in an engine portion. According to this device, a reinforcing plate is provided on an inner surface of an engine cover which covers the engine, and the reinforcing plate defines a space in the engine portion so as to form the resonant chamber.

According to this configuration, by using a space in the engine portion which is defined by the reinforcing plate, the resonant chamber of the air suction noise reduction device is formed. Therefore, compared to a prior configuration in which a box-shaped resonant chamber is formed separately from a vehicle body and the resonant chamber is connected to an intake passage reaching to the engine, the structure of the device is simple and is produced with low cost, and the resonant chamber can be arranged easily without preparing an installment space for the resonant chamber.

In the above air suction noise reduction device, it is preferable that the expansion chamber which forms a part of the intake passage is formed in a space defined by the reinforcing plate and the resonant chamber is connected to the expansion chamber via a port. In this case, the resonant chamber of the air suction noise reduction device is formed by using a space in the engine portion which is defined by the reinforcing plate. This simplifies the configuration of the device, and the device can be produced with low cost. Also, the expansion chamber is easily arranged without preparing an installment space for the expansion chamber.

In the above air suction noise reduction device, it is preferable that the reinforcing plate is formed to be bent. This improves the strength of the reinforcing plate and effectively reinforces the engine cover.

In the above air suction noise reduction device, it is preferable that a lower bent portion of the reinforcing plate forms a bottom surface of the expansion chamber and the resonant chamber. This requires no parts for forming the bottom surface of the expansion chamber and the resonant chamber. Therefore, this simplifies the structure of the device.

In the above air suction noise reduction device, it is preferable that a lower bent portion of the reinforcing plate is fixed to adjacent another reinforcing plate. Accordingly, the bent portion which forms the bottom surface of the expansion chamber and the resonant chamber reinforces portions between a plurality of reinforcing plates. This further improves the strength of the engine cover.

In the above air suction noise reduction device, it is preferable that a partition plate having a port is provided in a space defined by the reinforcing plate, and the partition plate defines a space in the engine portion into the resonant chamber and the expansion chamber. Accordingly, one partition plate defines the resonant chamber and the expansion chamber. This simplifies the structure of the device.

In the above air suction noise reduction device, it is preferable that the partition plate is provided between a plurality of reinforcing plates. Accordingly, the partition plate improves the strength of the portions between the plurality of reinforcing plates.

In the above air suction noise reduction device, it is preferable that a plurality of partition plates are provided and each partition plate defines a plurality of resonant chambers. If the plurality of resonant chambers have the same vibration reduction property, the intake noise having one frequency band is effectively reduced. If the plurality of resonant chambers have different vibration reduction properties, the intake noises having different frequency bands are effectively reduced.

In the above air suction noise reduction device, it is preferable that the engine cover includes a cover body and an engine hood which is attached to an opening portion formed on an upper surface of the cover body, and the reinforcing plate is provided on an inner surface of the engine hood. Accordingly, the air suction noise reduction device can be arranged in a space in the engine portion.

In the above air suction noise reduction device, it is preferable that the engine hood includes a top plate portion and side plate portions which are provided on both side edges of the top plate portion, and the reinforcing plate is arranged so as to reinforce a portion between the top plate portion and the side plate portions. Accordingly, the reinforcing plate effectively defines a space in the engine portion and effectively reinforces the engine hood.

In the above air suction noise reduction device, it is preferable that the reinforcing plate is fixed to an inner surface of the side plate at its both side edges and is fixed to the top plate portion at its top edge. Accordingly, the reinforcing plate is provided between the both side edges of the engine hood. This improves the strength of the engine hood.

In the above air suction noise reduction device, it is preferable that the resonant chamber reduces intake noise of a frequency band of 50 to 120 Hz. Accordingly, the intake noise in an area that makes human beings feel uncomfortable is reduced. This improves a working environment.

According to another aspect of the present invention, a work machine having the above described air suction noise reduction device is provided. Accordingly, a work machine having the above-described advantages is provided.

### BRIEF DESCRIPTION OF THE DRAWINGS

FIG. 1 is a perspective view showing a work machine provided with an air suction noise reduction device according to one embodiment;

FIG. 2(a) is an enlarged perspective view showing the air suction noise reduction device of FIG. 1;

FIG. 2(b) is an enlarged perspective view showing a reinforcing plate and a partition plate;

FIG. 3 is a cross-sectional view taken along line 3-3 of FIG. 2;

FIG. 4 is a cross-sectional view taken along line 4-4 of FIG. 3; and

FIG. 5 is a cross-sectional view taken along line 5-5 of FIG. 3.

### DETAILED DESCRIPTION OF THE PREFERRED EMBODIMENTS

One embodiment of the present invention will be described with reference to the drawings.

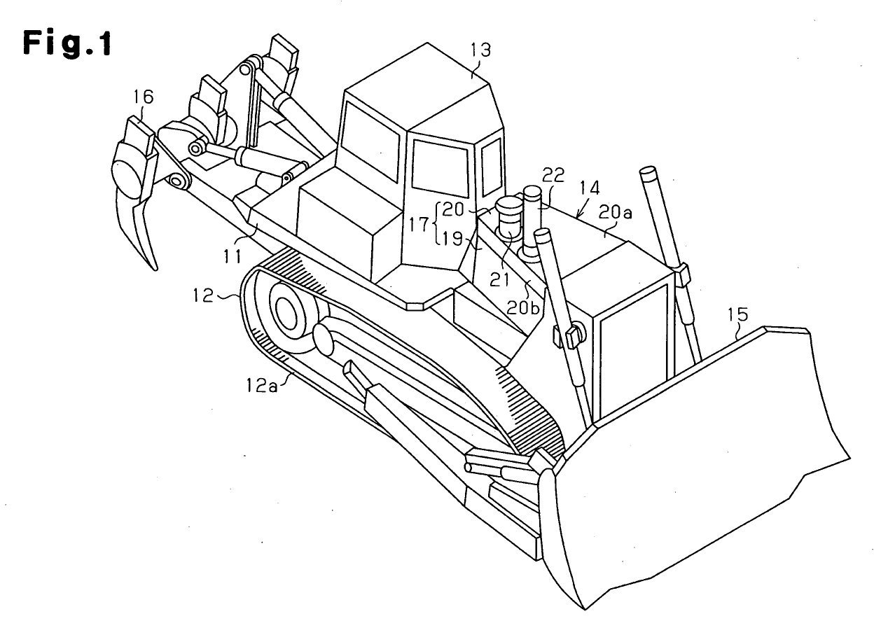

As shown in FIG. 1, a bulldozer, which is a work machine, has a frame 11. A travel unit 12 including a continuous track 12a is provided under the frame 11. A cab 13 and an engine portion 14 are provided on the frame 11. Work implements 15, 16 such as a bulldozing blade or a ripper are provided on a front portion and a rear portion of the frame 11, respectively.

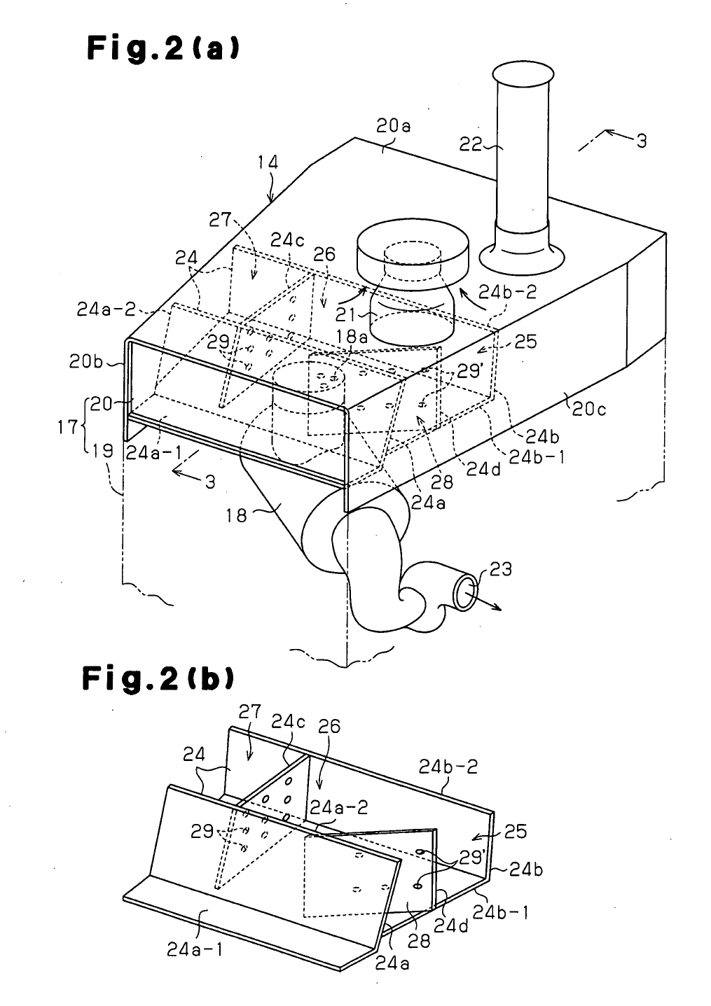

As shown in FIG. 2(a), an outer wall of the engine portion 14 is comprised of an engine cover 17. Various devices such as an engine (not shown) and an air cleaner 18 which is connected to an air intake side of the engine are accommodated in the engine portion 14. The engine cover 17 is comprised of a substantially box-shaped cover main body 19 and an engine hood 20 which is mounted to an opening portion of the upper surface of the cover main body 19. A door (not shown) for checking is provided on a side wall of the cover main body 19.

The engine hood 20 includes a top plate portion 20a and a pair of side plate portions 20b, 20c which extends downwardly from both side ends of the top plate portion 20a so as to be formed like a door. An intake cylinder 21 and an exhaust cylinder 22 are provided on the top plate portion 20a. The intake cylinder 21 forms a part of an intake passage 23 which reaches the engine and the exhaust cylinder 22 has a intake noise muffler (not shown) therein. Air is drawn into the engine from the intake cylinder 21 and exhaust gas is exhausted from the exhaust cylinder 22.

As shown in FIGS. 2(a) and 2(b), a plurality of reinforcing plates 24 are fixed to an inner surface of the engine hood 20 by welding. Each of the reinforcing plates 24 is arranged along a longitudinal direction and a width direction of the engine hood 20. Each of the reinforcing plates 24 reinforces the engine hood 20. The first to fourth reinforcing plates 24a-24d of the reinforcing plates form an air suction noise reduction device 25 which is positioned on the intake passage 23.

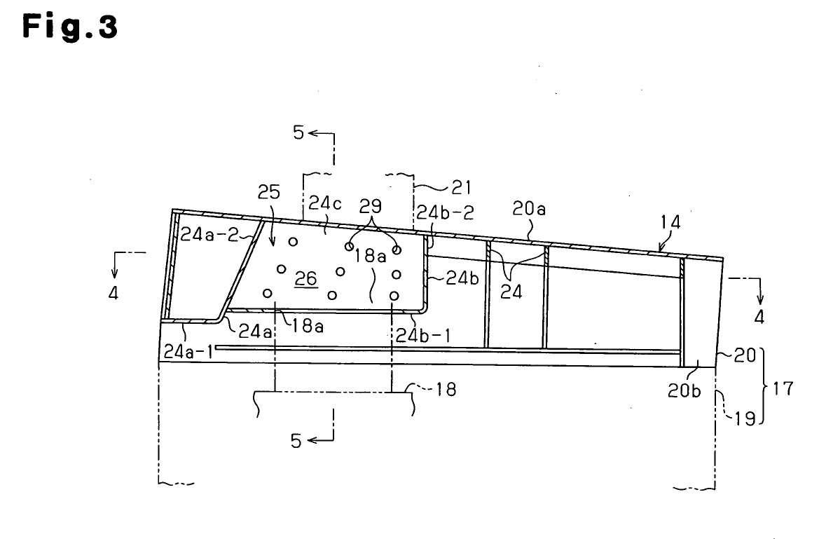

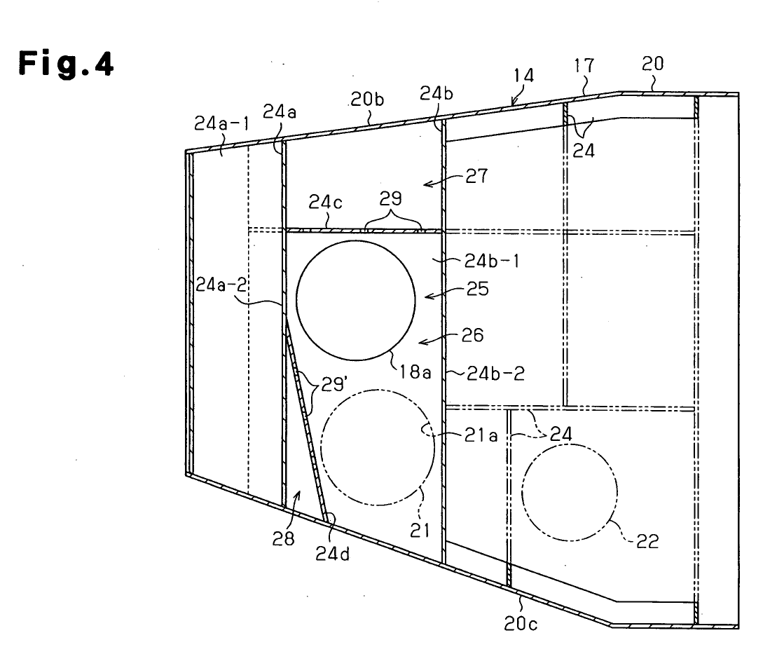

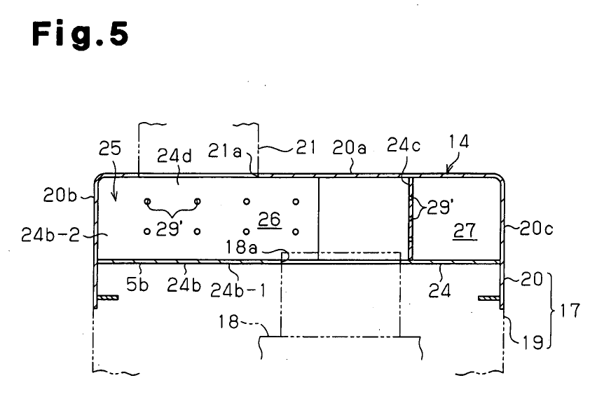

As shown in FIGS. 2 to 5, among the reinforcing plates 24, the first and second reinforcing plates 24a, 24b which are adjacent to each other and arranged along the longitudinal direction are bent at a certain angle. Both side ends of the first and second reinforcing plates 24a, 24b are welded to the inner surfaces of the side plate portions 20b, 20c of the engine hood 20. Upper ends of the first and second reinforcing plates 24a, 24b are welded to the inner surface of the top plate portion 20a. A lower bent portion 24b-1 of the second reinforcing plate 24b is welded to a rear surface of an upper bent portion 24a-2 of the first reinforcing plate 24a. The first and second reinforcing plates 24a, 24b define an inner space of the engine portion 14, whereby forming an expansion chamber 26 which forms a part of the intake passage 23. The volume of the expansion chamber 26 is greater than that of the intake passage 23 which is positioned at an upper stream side and a lower stream side of the expansion chamber 26. An intake port 21a is formed on the upper surface of the expansion chamber 26, that is, at a position of the top plate portion 20a of the engine hood 20 where the lower end of the intake cylinder 21 is attached. An intake port 18a is formed on the lower surface of the expansion chamber 26, that is, at a position of the lower bent portion 24b-1 where the air cleaner 18 is attached.

In the vicinity of the side plate portion 20b of the engine hood 20, a third reinforcing plate 24c, which is a partition plate, is provided between the upper bent portion 24a-2 of the first reinforcing plate 24a and the upper bent portion 24b-2 of the second reinforcing plate 24b. The third reinforcing plate 24c is welded to the upper bent portion 24a-2 and the upper bent portion 24b-2. The third reinforcing plate 24c defines a part of the expansion chamber 26 so as to form a first resonant chamber 27 having intake noise reducing function. The first resonant chamber 27 is formed in a rectangle shape in plan view. In the vicinity of the side plate portion 20c of the engine hood 20, a fourth reinforcing plate 24d, which is another partition plate, is provided between the upper bent portion 24a-2 of the first reinforcing plate 24a and the lower bent portion 24b-1 of the second reinforcing plate 24b. The fourth reinforcing plate 24d is welded to the upper bent portion 24a-2 and the lower bent portion 24b-1. The reinforcing plate 24d, which is positioned in a slanted manner, defines a part of the expansion chamber 26 so as to form a second resonant chamber 28 having intake noise reducing function. The resonant chamber 28 is formed in a triangle shape in plan view. Therefore, the lower bent portion 24b-1 of the second reinforcing plate 24b forms lower surfaces of the expansion chamber 26, the first resonant chamber 27, and the second resonant chamber 28. Ports 29, 29′ which are comprised of a plurality of small holes are formed in the third and fourth reinforcing plates 24c, 24d, respectively. The third and fourth reinforcing plates 24c, 24d define the first and second resonant chambers 27, 28. The ports 29, 29′ connect each of the resonant chambers 27, 28 with the expansion chamber 26. This configuration allows sonic waves to be propagated between each of the resonant chambers 27, 28 and the expansion chamber 26. The number of ports 29, 29′ formed in each reinforcing plate 24c, 24d may be one.

According to the above configuration, during an operation of the engine, when outer air is drawn from the intake cylinder 21 as shown by an arrow in FIG. 2(a), the outer air passes through the expansion chamber 26 and taken into the air cleaner 18. Then, the outer air is filtered by the air cleaner 18 and drawn to the engine. At this time, intake noise is generated at the air intake side of the engine. The intake noise is propagated in a direction opposite to the flow of the outer air and reaches the expansion chamber 26. In this case, the first and second resonant chambers 27, 28 which are connected to the expansion chamber 26 via the ports 29, 29′ reduce the intake noise of the frequency band which corresponds to the volume of the resonant chambers 27, 28 and the diameter of the ports 29, 29′. Generally, the frequency area which makes human beings to feel uncomfortable is 50-120 Hz. In this embodiment, the volume of the resonant chambers 27, 28 and the diameter of the ports 29, 29′ are respectively set so as to reduce the intake noise of the low frequency band of 70 Hz. Sound resonance caused by the intake noise generated in the vicinity of the engine almost has the low frequency band. Noise generated when the engine used for a work machine is driven at a high rotational area (approximately 2400 rpm) is approximately 120 Hz (if the speed of the engine is lowered, the frequency is also decreased). In this embodiment, the resonant chambers 27, 28 have the same vibration reduction property and reduce the intake noise of the same frequency band.

The embodiment described above has the following advantages.

(1) In the above embodiment, the intake noise of a certain frequency band can be reduced. Therefore, noise of the certain frequency band is hardly propagated to the cabin 13 and a comfortable working environment is achieved. Especially, if the intake noise of a frequency band of 70 Hz, which makes human beings to feel most uncomfortable, is reduced, an operator can carry out the operation comfortably.

(2) The reinforcing plates 24a to 24d, which reinforce the engine hood 20, define the expansion chamber 26 and the resonant chambers 27, 28. In other words, the reinforcing plates 24a to 24d form the intake noise reducing mechanism and also eliminate the connection parts such as pipes. Further, dedicated space for the intake noise reducing mechanism is not necessary to be prepared. Therefore, the structure of the air suction noise reduction device 25 can be made simple and the space in the engine compartment can be effectively used.

(3) The resonant chambers 27, 28 have the same vibration reduction property and are formed to reduce the intake noise having the same frequency band. Therefore, the intake noise having a certain frequency band is effectively reduced. For example, by changing the diameter of the ports 29, 29′, the vibration reduction property of the resonant chambers 27, 28 can be made different such that the intake noises having a plurality of frequency bands are reduced. In this case, an operator can carry out the operation more comfortably.

(4) The engine hood 20 serves as the upper surface and the side surfaces of the expansion chamber 26, the first resonant chamber 27 and the second resonant chamber 28. The lower bent portion 24b-1 of the second reinforcing plate 24b serves as the bottom surface of the expansion chamber 26, the first resonant chamber 27 and the second resonant chamber 28. This reduces the number of parts and makes the structure of the device simple.

(5) The first and second reinforcing plates 24a, 24b are fixed to the inner surfaces of the side plate portions 20b, 20c and also fixed to the inner surface of the top plate portion 20a. This improves the strength of the engine hood 20.

(6) The first and second reinforcing plates 24a, 24b, which form the expansion chamber 26, the first resonant chamber 27, and the second resonant chamber 28, are bent. This improves the strength of the first and second reinforcing plates 24a, 24b and also improves the strength of the entire engine hood 20. Further, the lower bent portion 24b-1 of the second reinforcing plate 24b is fixed to the rear surface of the upper bent portion 24a-2 of the first reinforcing plate 24a. This further improves the strength of the first and second reinforcing plates 24a, 24b.

(7) Since the third reinforcing plate 24c is provided between the first and second reinforcing plates 24a, 24b, the strength of the first and second reinforcing plates 24a, 24b is further improved.

The illustrated embodiment may be modified as follows.

In the illustrated embodiment, the air suction noise reducing device 25 is arranged on the engine cover 17 of the engine portion 14 of the bulldozer. However, the present invention may be applied to other work machines such as a hydraulic excavator or a tractor.

In the illustrated embodiment, the expansion chamber 26 and the resonant chambers 27, 28 are formed in the engine hood 20. However, the expansion chamber 26 and the resonant chambers 27, 28 may be formed in the cover main body 19.

In the illustrated embodiment, the expansion chamber 26 may be omitted. In this case, the intake passage 23 does not need to have a portion of which the volume is larger than other portions, and the resonant chamber may be connected to a part of the intake passage 23 via a port.

In the illustrated embodiment, three or more resonant chambers may be formed.

In the illustrated embodiment, a noise absorbing material may be adhered to the inner surfaces of the expansion chamber 26 and the resonant chambers 27, 28. This reduces the intake noise. In this case, not only intake noise having low frequency waves, but also intake noise having high frequency waves may be reduced by the noise absorbing material.

In the illustrated embodiment, a laminated damping steel sheet which is formed by holding a damping material between steel plates may be used for the reinforcing plates 24c, 24d. This also reduces the intake noise.

In the illustrated embodiment, a port may be formed on one or both of the first and second reinforcing plates 24a, 24b and a resonant chamber may be formed outside of the expansion chamber 26. This increases the number of the resonant chambers.

In the illustrated embodiment, the first and second reinforcing plates 24a, 24b may be formed in a triangle shape. In this case, one edge of the first and second reinforcing plates 24a, 24b may be fixed to the inner surface of the side plate portion 20b of the engine hood 20, and another edge may be fixed to the inner surface of the top plate portion 20a.

In the illustrated embodiment, the reinforcing plates 24c, 24d may be formed of a flexible plate or a curved plate. This increases the volume of the resonant chamber which is defined by the reinforcing plates.

1. An air suction noise reduction device in which an resonant chamber having an intake noise reducing function is connected to a intake passage via a port, the intake passage reaching an engine which is accommodated in an engine portion,
the air suction noise reduction device being characterized in that a reinforcing plate is provided on an inner surface of an engine cover which covers the engine, the reinforcing plate being, at both side edges, fixed to inner surfaces of the engine cover, the reinforcing plate defining a space in the engine portion, thereby forming the resonant chamber.

2. The air suction noise reduction device according to claim 1, being characterized in that an expansion chamber which forms a part of the intake passage is formed in a space defined by the reinforcing plate, and the resonant chamber is connected to the expansion chamber via a port.

3. The air suction noise reduction device according to claim 2, being characterized in that the reinforcing plate is formed to be bent.

4. The air suction noise reduction device according to claim 3, being characterized in that a lower bent portion of the reinforcing plate forms a bottom surface of the expansion chamber and a bottom surface of the resonant chamber.

5. The air suction noise reduction device according to claim 3, being characterized in that a lower bent portion of the reinforcing plate is fixed to adjacent another reinforcing plate.

6. The air suction noise reduction device according to claim 2, being characterized in that a partition plate having a port is provided in a space defined by the reinforcing plate, and the partition plate divides a space in the engine portion into the resonant chamber and the expansion chamber.

7. The air suction noise reduction device according to claim 6, being characterized in that the partition plate is provided between a plurality of reinforcing plates.

8. The air suction noise reduction device according to claim 6, being characterized in that each partition plate defines a plurality of resonant chambers.

9. The air suction noise reduction device according to claim 6, being characterized in that the engine cover includes a cover body and an engine hood which is attached to an opening portion formed on an upper surface of the cover body, and the reinforcing plate is provided on an inner surface of the engine hood.

10. The air suction noise reduction device according to claim 9, being characterized in that the engine hood includes a top plate portion and side plate portions which are provided on both side edges of the top plate portion, and the reinforcing plate is arranged so as to reinforce a portion between the top plate portion and the side plate portions.

11. (canceled)

12. (canceled)

13. (canceled)

14. An air suction noise reduction device in which an resonant chamber having an intake noise reducing function is connected to a intake passage via a port, the intake passage reaching an engine which is accommodated in an engine portion,
the air suction noise reduction device comprising:
a reinforcing plate is provided on an inner surface of an engine cover which covers the engine, the reinforcing plate being, at both side edges, fixed to inner surfaces of the engine cover , the reinforcing plate defining a space in the engine portion, thereby forming the resonant chamber.

15. The air suction noise reduction device according to claim 14, wherein:
an expansion chamber which forms a part of the intake passage is formed in a space defined by the reinforcing plate, and the resonant chamber is connected to the expansion chamber via a port.

16. The air suction noise reduction device according to claim 15, wherein:
the reinforcing plate is formed to be bent.

17. The air suction noise reduction device according to claim 16, wherein:
a lower bent portion of the reinforcing plate forms a bottom surface of the expansion chamber and a bottom surface of the resonant chamber.

18. The air suction noise reduction device according to claim 16, wherein:
a lower bent portion of the reinforcing plate is fixed to adjacent another reinforcing plate.

19. The air suction noise reduction device according to claim 15, wherein:
a partition plate having a port is provided in a space defined by the reinforcing plate, and the partition plate divides a space in the engine portion into the resonant chamber and the expansion chamber.

20. The air suction noise reduction device according to claim 19, wherein:
the partition plate is provided between a plurality of reinforcing plates.

21. The air suction noise reduction device according to claim 19, wherein:
each partition plate defines a plurality of resonant chambers.

22. The air suction noise reduction device according to claim 19, wherein:
the engine cover includes a cover body and an engine hood which is attached to an opening portion formed on an upper surface of the cover body, and the reinforcing plate is provided on an inner surface of the engine hood.

23. The air suction noise reduction device according to claim 22, wherein:
the engine hood includes a top plate portion and side plate portions which are provided on both side edges of the top plate portion, and the reinforcing plate is arranged so as to reinforce a portion between the top plate portion and the side plate portions.
